(19) United States
(12) Patent Application Publication
(10) Pub. No.: US 2012/0144052 A1
(43) Pub. Date: Jun. 7, 2012

(54) BACKGROUND SERVICE PROCESS UNIT, POSITION SYSTEM AND CALL CONTROL METHOD THEREOF

(75) Inventor: Jun Zhong, Shenzhen City (CN)

(73) Assignee: ZTE CORPORATION, Shenzhen City, Guangdong (CN)

(21) Appl. No.: 13/376,709

(22) PCT Filed: Dec. 21, 2009
(86) PCT No.: PCT/CN2009/075785

§ 371 Date: Dec. 7, 2011

(30) Foreign Application Priority Data
Aug. 26, 2009 (CN) 200910169360.3

(51) Int. Cl. G06F 15/16

(52) U.S. Cl. 709/230

(57) ABSTRACT

The invention discloses a background service process unit, a position system and a method for call control thereof. The method includes: a browser sending an operation request according to a customer representative to a background service process unit through an operation page; the background service process unit judging whether the operation can be performed currently, if yes, sending the operation request to a CTI server; the CTI server forwarding the received operation request to an automatic call distributor for performing, and forwarding an operation completion notification message, after the operation request is performed completely, to the background service process unit; the background service process unit making a switching to a position state according to the operation completion notification message.

### TECHNICAL FIELD

The present invention relates to network communication and call center application technology, and especially to a background service process unit, a position system and a call control method thereof.

### BACKGROUND OF THE RELATED ART

Along with the high-speed development of internet, IP based internet gradually becomes a necessary tool in daily work and life of people, and a browser has been widely used by various users as the most important tool for people to access internet information.

A browser is easily obtained as a fundamental function software, and various browsers commonly have extensibility. The software implemented based on browsers are bound to have a certain advantage on easy deployment, high extensibility.

The existing position system usually uses a program structure of client/server (C/S) model. Along with the migration of a common telephone network to an IP network, the advantages of several networks merge with each other. The disadvantages of the existing call center position system on deployment, maintenance, reliability and other aspects become more and more apparent, which are specifically as follows:

1) not easy to deploy: the existing position system uses a conventional software release manner, which needs manual installation and configuration, and thus is time consuming and laborious.

2) not easy to maintain: each position system is a separate copy and must be configured respectively since deployment is made in installation manner. Once the program is exceptional and needs to be replaced or its configuration needs to be adjusted, labor power has to be spent to process the machines one by one.

3) weak reliability: the service logic and call control are tightly bound with each other since no hierarchical design is used, and once a service module is in trouble, the call will be caused to end exceptionally.

### SUMMARY OF THE INVENTION

The present invention provide a background service process unit, a position system and a method for call control thereof, enabling a customer representative to login to a CTI server and process a call through a browser in a common computer host by installing a background server process unit in the common computer host.

The technical scheme of the invention comprises:

a background service process unit, comprising a protocol stack module, a state machine module and a service end access interface module, wherein,

the protocol stack module, connected to a CTI server and an automatic call distributor, is used to send and receive a TSAPI message and a SIP message, parse a result of message sending and content of a received message, and deliver an parsed message to the state machine module for processing;

the state machine module, interfaced with the service end access interface module, is used to provide validity detection for an operation of a customer representative according to a position state and/or a call state, and maintain the position state and the call state according to a TSAPI message and a SIP message that have been received;

the service end access interface module is used to provide interfaces of position state and call state control for the customer representative.

The protocol stack module specifically comprises a TSAPI protocol stack module and a SIP protocol stack module, and the state machine module specifically comprises a position state machine module and a call state machine module; wherein,

the TSAPI protocol stack module, connected to a CTI server through an IP network, is used to create and release a TSAPI connection, send and receive a TSAPI message, parse an acknowledgment of message sending and content of a received message, and deliver a parsed message to the position state machine module for further processing;

the SIP protocol stack module, connected to the automatic call distributor through an IP network, is used to send and receive a SIP message, parse the received SIP message and deliver the parsed SIP message to the call state machine module for further processing;

the position state machine module is used to maintain the state of a position according to a received TSAPI message, and provide control and query of the position state;

the call state machine module is used to maintain the state of a call according to a TSAPI message and a SIP message that have been received, provide call state query, call control operation and operation validity detection.

The background service process unit further comprises:

a FTP protocol stack module, used to provide FTP file transfer ability;

an update detection module, communicating with the service end access interface module and the FTP protocol stack module, used to inquire a FTP server regularly through the FTP protocol stack module, check whether a position software has an update, and if an update is discovered, initiate a FTP operation to download the update and register a new position software.

The background service process unit further comprises:

a RTP protocol stack module, used to send and receive media stream packets under control of the SIP protocol stack module, and deliver received media data to a media encoding and decoding module for processing;

a media encoding and decoding module, communicating with the RTP protocol stack module and responsible for encoding and decoding operations of the media data, used to, after a voice captured by a voice capturing device is converted into digital signals by a voice card, perform encoding compression to the digital signals obtained after the conversion, encapsulate the digital signals after the encoding compression into a RTP message, which is then sent to a correspondent node through the RTP protocol stack module, and deliver decoded data streams to the voice card for reduction synthesis and broadcast through a voice broadcast device.

The background service process unit further comprises:

a data access client module, communicating with the service end access interface module, used to provide access function of a position system database for the customer representative after the customer representative initiates a data query operation through an operation web page;

the service end access interface module is further used to provide an access interface of the position system database for the customer representative.

A browser based position system, comprises a browser and a background service process unit, wherein,

the browser is used to send an operation request according to a customer representative to the background service process unit through an operation page, the browser comprises an interface access object, which is used to send the operation request from the customer representative to a service end access interface module of the background service process unit;

the background service process unit, connected to a CTI server and an automatic call distributor, is used to receive the operation request, judge whether the operation can be performed currently, if yes, send the operation request to the CTI server through a TSAPI protocol, and make a corresponding switching to a position state after receiving an operation completion notification message sent by the CTI server;

the CTI server forwards the received operation request to the automatic call distributor for performing, and forwards, after the performing is completed, the operation completion notification message sent by the automatic call distributor to the background service process unit.

The browser is further used to send a login request from the customer representative to the background service process unit through a login page, and switch a current login page to the operation page after receiving a returned login result message;

the background service process unit is further used to receive the login request, judge whether the customer representative can perform a login operation currently, if yes, then initiate a TSAPI protocol registration to the CTI server, and set a corresponding position state and initiate a SIP protocol registration to the automatic call distributor after the TSAPI protocol registration is successful, and set a corresponding call state and send a login result to the login page opened by the customer representative after the SIP protocol registration is successful.

A method for call control of a browser based position system comprises steps:

A, a browser sending an operation request according to a customer representative to a background service process unit through an operation page;

B, the background service process unit receiving the operation request, and judging whether the operation can be performed currently, if yes, sending the operation request to a CTI server;

C, the CTI server forwarding the received operation request to an automatic call distributor for performing, and forwarding an operation completion notification message sent by the automatic call distributor to the background service process unit after the operation request is performed completely;

D, the background service process unit making a corresponding switching to a position state according to the received operation completion notification message.

The specific process for the automatic call distributor to perform the operation are as follows:

after receiving the operation request, the automatic call distributor sending a corresponding operation command to the background service process unit through a SIP protocol;

after receiving the operation command, the background service process unit performing a corresponding media stream control operation, and making a corresponding switching to a call state, thereafter returning an operation completion confirmation message to the automatic call distributor through the SIP protocol;

after receiving the operation completion confirmation message, the automatic call distributor sending an operation completion notification message to the CTI server.

Before the step A, the method further comprises the following steps:

the browser sending a login request of the customer representative to the background service process unit through a login page;

the background service process unit receiving the login request, and judging whether the customer representative can perform a login operation currently, if yes, initiating a TSAPI protocol registration to the CTI server, setting a corresponding position state and initiating a SIP protocol registration to the automatic call distributor after the TSAPI protocol registration is successful, and setting a corresponding call state and sending a login result to the login page which is opened by the position after the SIP protocol registration is successful.

After receiving the login request, when the background service process unit judges whether the customer representative can perform the login operation currently, if the background service process unit discovers the customer representative is currently in a conversation state and a current service session is not connected to the customer representative, the background service process unit returns a message for prompting whether to connect to the service session to the login page, and when receiving a returned connection request, the background service process unit recreates a connection for the service session.

The advantages of the invention are as follows:

the technical scheme of the invention enables a customer representative to login to a CTI server and process a call through a browser in a common computer host by simply downloading a background server process unit into the common computer host at the first access. The technical scheme of the invention gives full display of the advantages of easy deployment and high extensibility of a browser, and meanwhile solves the reliability problem of the browser through a design of software structure, thereby realizing a browser based position system with easy deployment, high reliability and high extensibility. The position system has the following desirable characteristics:

1) Easy Deployment

By using the browser based position system of the invention, the time and labor expense spent on release, installation, maintenance of software are saved, and the operation maintenance cost is greatly reduced. Since the installation and deployment conditions are very low, the position system of the invention is adapted to most computer systems (desktop computers, notebook computers, UMPC and so on), and is also adapted to part of intelligent products (such as smart phones), thus realizing cross-platform features.

2) High Reliability

A conventional position system uses a framework based program structure, and a call control module and a business process module are not differentiated based on importance, thus causing an important call module to be influenced easily by a secondary module, or even causing a call to be interrupted exceptionally. In the software structure of the position system of the invention, the data and program modules are differentiated based on importance during running, and important data are placed in separate processes, thereby ensuring the safety of core programs, and improving the reliability of the whole software structure of the position system.

3) High Extensibility

The position system of the invention reduces the limitation conditions for web services, and thus makes the development and customization of web services more flexible.

In addition, the background service process unit in the position system of the invention includes automatic update mechanism. When the software structure of a position system needs to upgrade, an automatic upgrade could be done only by placing a new edition on the FTP server. Since software automatic upgrade is adopted, the synchronicity and timeliness of software upgrade are ensured, thereby accelerating the tempo for fault response and requirement implementation, and greatly improving use experience of users and enhancing user satisfaction.

### BRIEF DESCRIPTION OF DRAWINGS

FIG. 1 is a structure block diagram of the background service process unit of the invention;

FIG. 2 is a structure block diagram of a browser based position system of the invention;

FIG. 3 is a timing sequence flowchart of the method for realizing position login through the browser based position system of the invention;

FIG. 4 is a timing sequence flowchart of the method for realizing position call control through the browser based position system of the invention;

FIG. 5 is a timing sequence flowchart of the method for realizing exception situation recovery through the browser based position system of the invention.

### PREFERRED EMBODIMENTS OF THE PRESENT INVENTION

The core concept of the invention is that a customer representative is able to login to the computer telephony integration (CTI) server and process a call only through a browser by installing a background server process unit in the host of the position side. The core of using the background service process as the backbone of a browser based position system is that the various function modules within the position system are differentiated based on importance, and modules with different importance are isolated from each other in different processes and are not influenced by each other according to isolation mechanism, i.e., programs and data in different processes are isolated physically. The reliability of an important module is prevented from being reduced due to influence of an unimportant module on the important module, thereby ensuring the reliability of the whole position system.

The specific implementation process of the invention will be further described in detail below with reference to all the accompanying drawings.

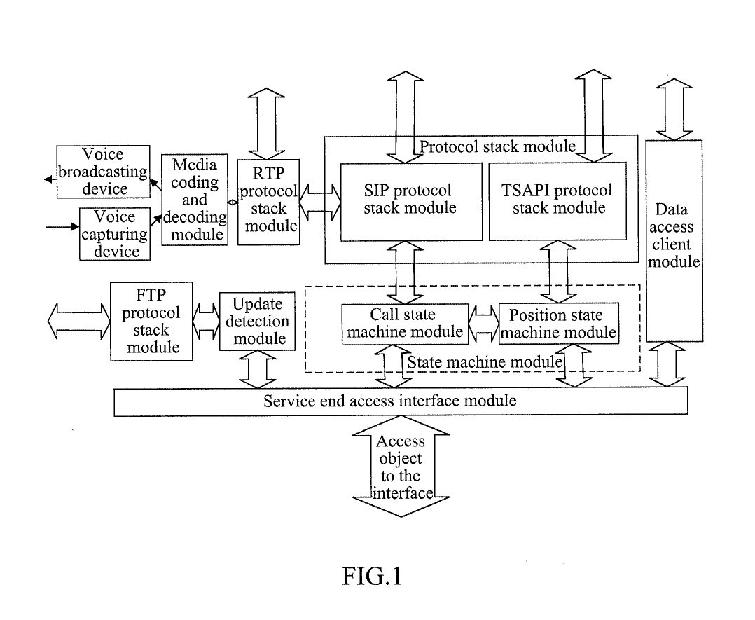

Please refer to FIG. 1, it is a structure block diagram of the background service process unit of the invention, which mainly includes a protocol stack module, a state machine module and a service end access interface module, wherein,

the protocol stack module, connected to a CTI server and an automatic call distributor (ACD), is used to send and receive a telephony service application programming interface (TSAPI) message and a session initiation protocol (SIP) message, analyze the result of message sending and the content of a received message, and deliver an analyzed message to the state machine module for processing;

the state machine module, connected to the service end access interface module, is used to provide validity detection for an operation of a customer representative according to a position state and/or a call state, and maintain the position state and call state according to received TSAPI message and SIP message;

the service end access interface module is used to provide interfaces of position state and call state control for the customer representative.

Specifically, the protocol stack module specifically comprises a TSAPI protocol stack module and a SIP protocol stack module, and the state machine module specifically comprises a position state machine module and a call state machine module; wherein,

the TSAPI protocol stack module, connected to a CTI server through an IP network, is used to create and release a TSAPI protocol, send and receive a TSAPI message, parse the acknowledgment of message sending and the content of a received message, and deliver an parsed message to the position state machine module for processing;

the SIP protocol stack module, connected to the automatic call distributor through an IP network, is used to send and receive a SIP message, parse a received SIP message and deliver the parsed SIP message to the call state machine module for processing;

the position state machine module is used to maintain the state of a position according to a received TSAPI message, and provide control and query of the position state;

the call state machine module is used to maintain the state of a call according to the received TSAPI message and SIP message, provide call state query, call control operation and operation validity detection.

Furthermore, the background service process unit further comprises:

a real-time transport protocol (RTP) protocol stack module, used to send and receive media stream packets, and deliver received media data to the media encoding and decoding module for processing; the start and stop of the sending and receiving processes of the media stream data being controlled by the SIP protocol stack;

a media encoding and decoding module, communicating with the RTP protocol stack module and responsible for encoding and decoding operations of media data, used to, after a voice captured by a voice capturing device is converted into digital signals by a voice card, perform encoding compression to the digital signals obtained after the conversion, encapsulate the digital signals after the encoding compression into a RTP message, which is then sent to a correspondent node through the RTP protocol stack module, and deliver decoded data streams to the voice card for reduction synthesis and broadcast through a voice broadcast device.

To realize the automatic upgrade of a client (position) software and ensure the synchronization and timeliness of software upgrade, the background service process unit may further comprise:

a file transfer protocol (FTP) protocol stack module, used to provide FTP file transfer ability, realize automatic update of a position software, download of voice for reporting employ ID numbers, uploading of recording files and other functions;

an update detection module, communicating with the service end access interface module and the FTP protocol stack module, used to inquire a FTP server regularly through the FTP protocol stack module, check whether a position software has an update, and if an update is discovered, initiate a FTP operation to download the update and register a new position software.

To provide the access function of the position system database, the service end access interface module is further used to provide an access interface of the position system database, and the background service process unit may further comprise:

a data access client module, communicating with the service end access interface module, used to provide access function of a position system database for the customer representative through the service end access interface module after the customer representative initiates a data query operation through the operation page.

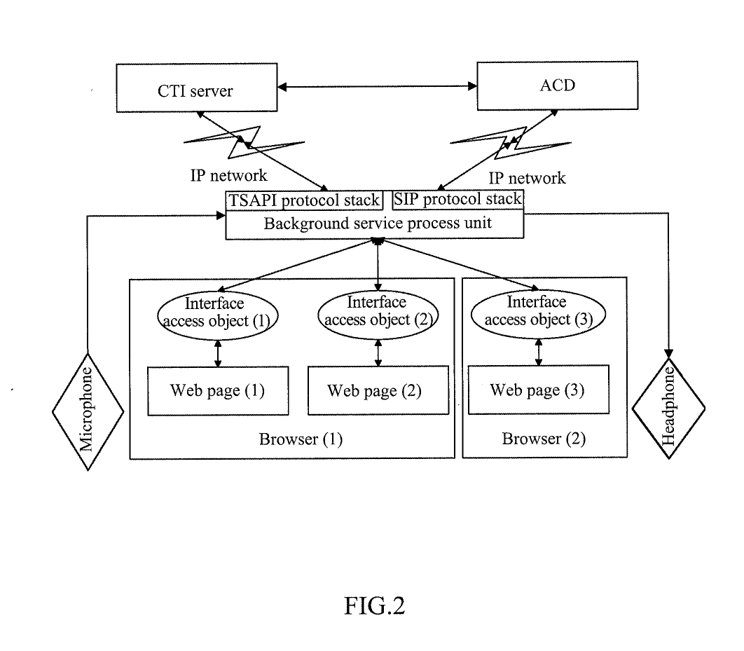

Please see FIG. 2, the diagram is a structure block diagram of a browser based position system of the invention. The position system enables a customer representative to login to a CTI server and process a call through a browser by installing the background server process unit shown in FIG. 1 on the host of the position side. The position system mainly comprises a browser and a background service process unit, wherein,

the browser is used to send a call operation request of a customer representative to the background service process unit through an interface access object using an opened web operation page, and show to the customer representative the operation result or operation completion notification returned by the background service process unit through the interface access object. Wherein,

the web operation page is used to implement a specific service flow, control a call and other objects to complete a specific service by invoking a service from the background service process unit;

the interface access object is used to provide an access interface of the background service process unit, which is created by a web operation page needing to use the background service progress function and run in the process of the web operation page, and between which and the service end access interface of the background service process unit an operation request initiated by the web operation page is delivered through the process;

the background service process unit is used to receive the call operation request, judge whether the operation can be performed currently, if yes, send the call operation request to the CTI server through a TSAPI protocol; after receiving an operation initiation confirmation message sent by the CTI server, make a corresponding switching to the position state, and send a corresponding operation result to the operation page currently opened by a position; after receiving a call operation command sent by the ACD, perform a corresponding media stream control operation, and make a corresponding switching to the call state, thereafter return to the ACD an operation completion confirmation message through SIP protocol; after receiving the operation completion notification message sent by the CTI server, make a corresponding switching to the position state, and send an operation completion notification message to the operation page opened currently by the position.

After receiving the call operation request, the CTI server returns to the background service process unit an operation initiation confirmation message, and meanwhile forwards the call operation request to the ACD for performing; and after the ACD finishes the call operation, forwards the operation completion notification message sent by the ACD to the background service process unit.

After receiving the call operation request sent by the CTI server, the ACD sends a corresponding call operation command to the background service process unit through the SIP protocol, and sends to the CTI server an operation completion notification message after receiving the operation completion confirmation message returned by the background service process unit.

Furthermore, during the login process of a position,

the browser is further used to send a login request of a customer representative to the background service process unit through an opened web login page, and switch the current web login page to a web operation page after receiving a returned login result message;

the background service process unit is further used to receive a login request sent by a customer representative through a browser, judge whether the customer representative can perform the login operation currently, if yes, initiate a TSAPI protocol registration to the CTI server, and set a corresponding position state and initiate a SIP protocol registration to the ACD after the TSAPI protocol registration is successful, and set a corresponding call state and return a login result to the web login page opened by the customer representative after the SIP protocol registration is successful.

After receiving the login request sent by the customer representative through the browser, when the background service process unit judges whether the customer representative can perform the login operation currently, if the background service process unit discovers the customer representative is currently in a conversation state and the current service session is not connected to a position, the background service process unit returns a message for prompting whether to connect to the service session to the opened login page, and when receiving a returned connection request, the background service process unit recreates a connection for the service session.

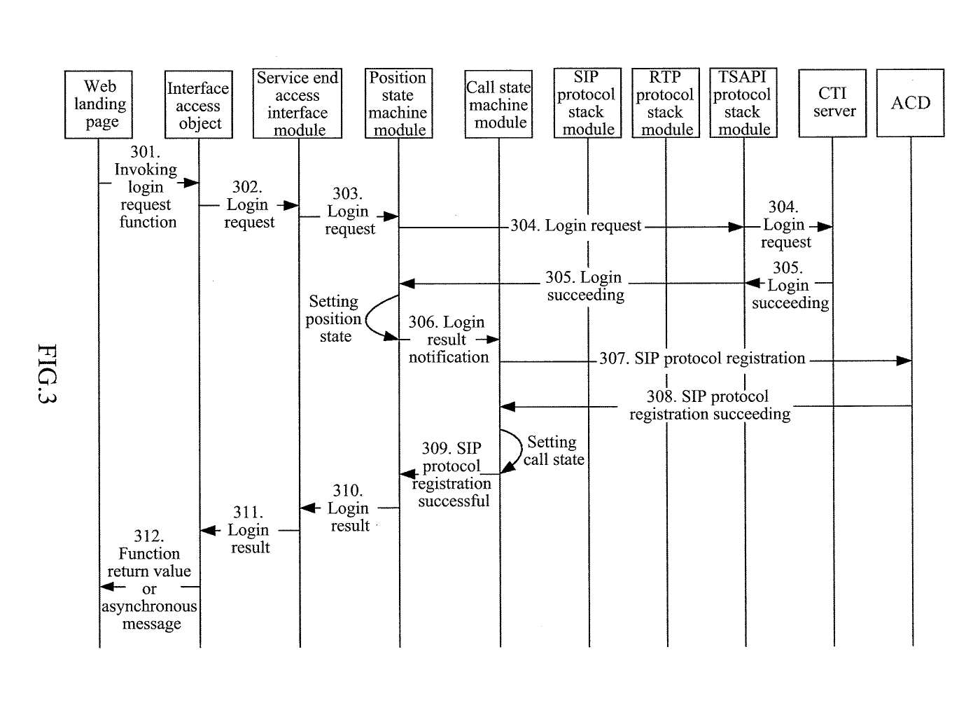

Please see FIG. 3, the diagram is a timing sequence flowchart of the method for realizing position login through the browser based position system of the invention, which mainly includes the following steps.

Step 301, a customer representative opens a browser of a position host, and enters the uniform resource locator (URL) address of a call center web server, and then opens a corresponding web login page and enters an account and a password to login according to the prompt on the web login page, and the web login page delivers a login request to an interface access object through invoking.

Step 302, the interface access object then delivers the login request to a service end access interface module of a background service process unit through inter-process communication.

Step 303, the service end access interface module analyzes the login request and gives it to a position state machine module for processing.

Step 304, the position state machine module checks whether the current position state can perform a login operation, for example, checking whether the state of the position state machine module is already in a login state, if yes, it is not allowed to re-login. The specific checking logic is determined according to the practical software requirements. If it is confirmed that the current position state is able to perform the login operation, the position state machine module invokes a TSAPI protocol stack module to send the login request to a CTI server.

Step 305, the CTI server responds to the TSAPI protocol stack module with a login success message, and the TSAPI protocol stack module analyzes the message and sends the analyzed message to the position state machine module for processing.

Step 306, the position state machine module analyzes the content of the message and judges that the login is successful, and then sets a corresponding position state, and simultaneously informs a call state machine module of the login result.

Step 307, the call state machine module initiates a SIP protocol registration to a ACD after receiving a notification from the position state machine module.

Step 308, the ACD confirms the success of the SIP protocol registration and sends a SIP protocol registration success message to the call state machine module.

Step 309, after receiving the SIP protocol registration success message, the call state machine module sets a corresponding call state, and informs the position state machine module of the SIP protocol registration success message.

Step 310, after receiving the notification from the call state machine module, the position state machine module confirms that logins to the CIT server and the ACD are both successful, and then determines that the whole login process is successful, and returns the login result to the service end access interface module.

Step 311, the service end access interface module returns the login result to the interface access object through inter-process communication.

Step 312, the interface access object delivers the login result to the web login page through a function return value or an asynchronous message; the web login page switches to a corresponding web operation page according to the login result.

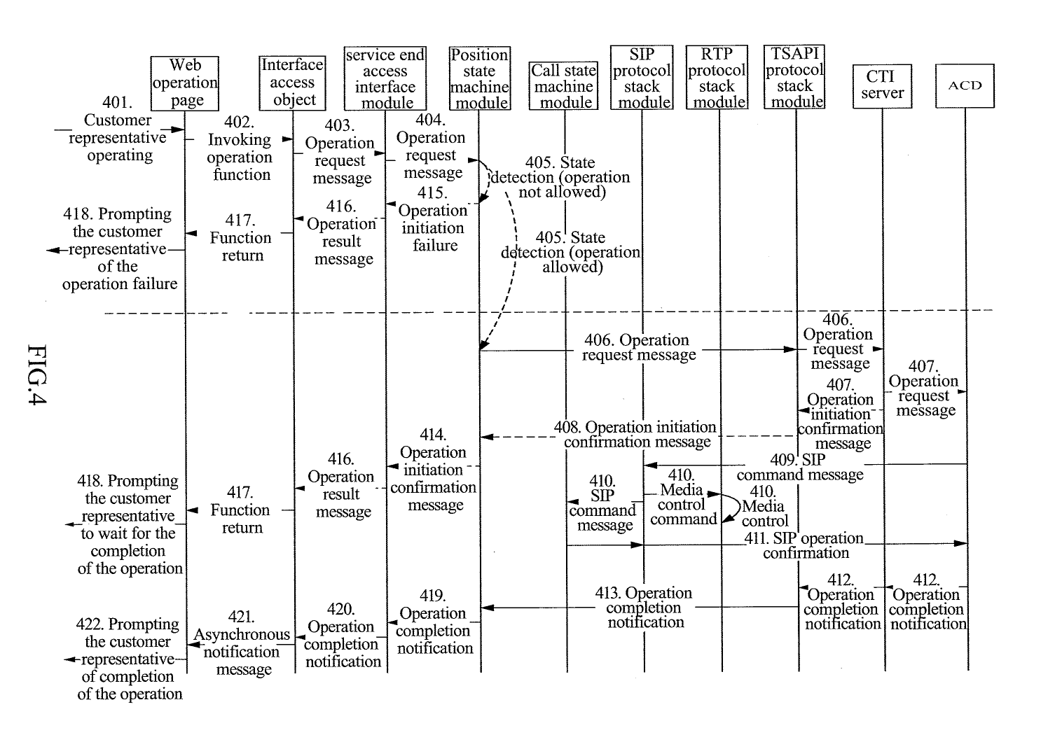

Please see FIG. 4, the diagram is a timing sequence flowchart of the method for realizing position call control through the browser based position system of the invention, which mainly includes the following steps.

Step 401, a customer representative performs a call control, such as holding, transferring, hanging up and so on, by clicking an operation button in a web operation page.

Step 402, the web operation page converts the operation of the customer representative to an operation request and sends to an interface access object through function invoking, and waits for function return.

Step 403, the interface access object delivers the operation request to a service end access interface module of the background service process unit through inter-process communication, the operation request including operation instructions, parameters and other information.

Step 404, the service end access interface module analyzes the received operation instructions, and judges by which module the instructions should be processed, and the call operation herein is given to a position state machine module for processing.

Step 405, the position state machine module makes an entrance test for the operation request: according to its own state and through inquiring the state of a call state machine module, it judges whether the call operation can be performed currently and checks whether parameters are valid, for example: a response operation is allowed to perform only when the position state machine module is in idle state and the call state machine module is in ringing state. The logical judgment in this section may be determined according to a specifically performed call operation. If the call operation is not allowed to perform, or parameters are wrong, the position state machine module will skip to step 415 to perform error processing.

Step 406, if the entrance test of the position state machine module is passed, the position state machine module invokes a TSAPI protocol stack module to send a call operation request to a CTI server.

Step 407, after receiving the call operation request, the CTI server returns to the TSAPI protocol stack module an operation initiation confirmation message, and simultaneously sends the call operation request to an ACD for processing.

Step 408, after receiving the operation initiation confirmation message, the TSAPI protocol stack module analyzes the message format, and delivers an analyzed message to the position state machine module for processing. Skip to step 414.

Step 409, after receiving the call operation request, the ACD sends a corresponding SIP command message to the SIP protocol stack module according to the operation instructions.

Step 410, after receiving the SIP command message, the SIP protocol stack module, according to the operation instructions, sends a corresponding media stream control instruction to a RTP protocol stack module, such as initiating the media stream, stopping the media stream, switching the media stream and so on, and simultaneously informs the call state machine module of the SIP command message.

Step 411, after receiving the SIP command message, the call state machine module makes a corresponding switching to the call state, and instructs the SIP protocol stack module to return an operation completion SIP confirmation message to the ACD.

Step 412, after receiving the SIP confirmation message, the ACD confirms the completion of the call operation, and sends an operation completion notification message to the CTI server, which then sends the operation completion notification message to the TSAPI protocol stack module.

Step 413, after receiving the operation completion notification message, the TSAPI protocol stack module analyzes the message and sends the analyzed message to the position state machine module for processing. Skip to step 419.

Step 414, after receiving the operation initiation confirmation message, the position state machine module makes a corresponding switching to the position state, and sends the operation result message (ACK) of the operation initiation confirmation to the service end access interface module. Skip to step 416.

Step 415, the position state machine module generates error codes according to the reason of failure, and sends the operation result message (NACK) of the failure of operation initiation to the service end access interface module.

Step 416, the service end access interface module sends the operation result message to the interface access object through inter-process communication.

Step 417, the function invoking of the interface access object by the web operation page in step 402 is ended and returned under the control of the interface access object, and the interface access object delivers the operation result to the web operation page through a function return value.

Step 418, according to the operation result returned by the function, the web operation page prompts the customer representative reasons of failure if the operation fails, and may instruct the customer representative to wait for the completion of the operation if the operation is successful, which suggests that the operation is initiated successfully but not yet completed.

Step 419, after receiving the operation completion notification message, the position state machine module makes a corresponding switching to the position state, and sends the operation completion notification message to the service end access interface module.

Step 420, the service end access interface module sends the operation completion notification message to the interface access through by inter-process communication.

Step 421, after receiving the operation completion notification message, the interface access object informs the web operation page through an asynchronous event.

Step 422, the web operation page prompts the customer representative of successful completion of the operation.

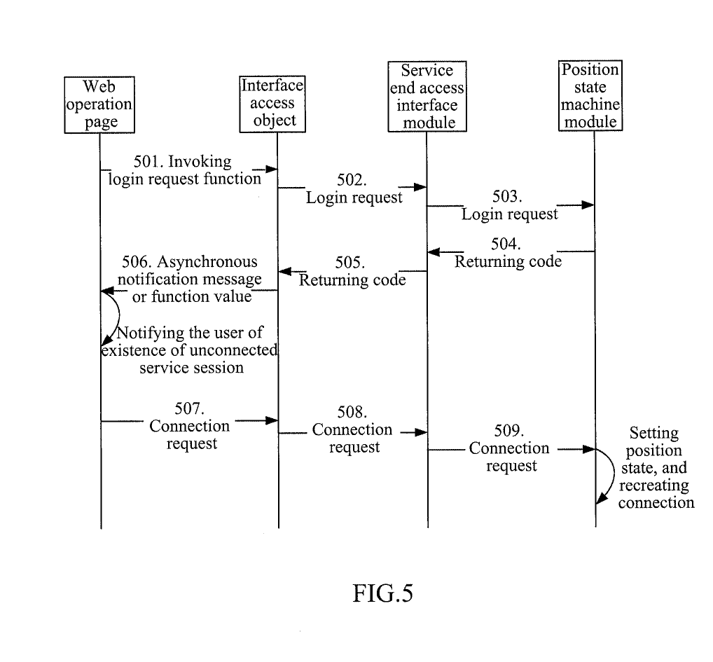

Please see FIG. 5, the diagram is a timing sequence flowchart of the method for realizing exception situation recovery through the browser based position system of the invention, which mainly includes the following steps.

Step 501, a browser breaks down when a customer representative is on a call, the customer representative continues to maintain the call with a user, and simultaneously opens a browser of a position host, enters the URL address of a call center web server, opens a web login page, and enters an account and a password to login according to the prompt in the web login page, and then the web login page sends a login request to an interface access object through invoking.

Step 502, the interface access object delivers the login request to the service end access interface module of the background service process unit through inter-process communication.

Step 503, the service end access interface module analyzes the login request and sends it to a position state machine module for processing.

Step 504, the position state machine module checks whether the current position state can perform the login operation, and when detecting that it is in a conversation state currently and the current service session is not connected to any position, it returns a code to the service end access interface module to indicate that an unconnected service session currently exists and whether to connect to the session.

Step 505, the service end access interface module returns the code to the interface access object through inter-process communication.

Step 506, the interface access object delivers, through a function return value or an asynchronous message, the code to the web login page, which then prompts the customer representative of whether to connect to the service session according to the returned code.

Step 507, if the customer representative determines to connect to the service session, the web login page delivers a connection request to the interface access object.

Step 508, the interface access object then delivers the connection request to the service end access interface module through inter-process communication.

Step 509, the service end access interface module gives the connection request to the position state machine module for processing, and the position state machine module reconfigures the position state and simultaneously recreates the connection.

In the example of the invention, important state management (position state, call state), important control message processing related to calls (SIP message, TSAPI message) and important processing related to the media (RTP transportation, media information encoding and decoding) are located in the background service process unit and are isolated from the secondary service processing logic (web page) with high failure rate, thereby ensuing the reliability of the whole position system. The reliability may also be subdivided into the continuity of connection, i.e. the position system will not cause a customer representative to quit from the CTI because of the exception of a web page, and the continuity of conversation, i.e. the conversation between a customer representative and a user will not be interrupted because of the exception of the web page.

With regard to the continuity of connection, when the web page quits exceptionally, the TSAPI protocol stack still continues to process TSAPI messages since the position state is located in the background service progress, thus making the connection of the position to the CTI still maintain valid. The web page could obtain the position state and proceed with the operation just by reconnecting to the background service progress after being reset.

With regard to the continuity of conversation, when the web page quits exceptionally, the SIP protocol stack still processes SIP messages since the call state is located in the background service progress, and the media process module still collects continually the voice codes of the customer representative and sends them to the user end, and meanwhile receives continually voice data from the user end through RTP, and restores with a sound card after decoding, thus enabling the customer representative to still hear the user's voice, and enabling the conversation to continue with no influence of exception situation of the web page. The web page could proceed to perform control operation to the call just by reconnecting to the background service progress after the web page is reset.

Obviously, those skilled in the art may make various modifications and variations to the invention without deviating from the spirit and scope of the invention. Thus, the invention is also intended to include these modifications and variations if these modifications and variations of the invention are within the scope of the claims of the invention and equivalent technologies thereof.

1. A background service process unit, comprising a protocol stack module, a state machine module and a service end access interface module, wherein,
the protocol stack module, connected to a CTI server and an automatic call distributor, is configured to send and receive a TSAPI message and a SIP message, analyze a result of message sending and content of a received message, and deliver an analyzed message to the state machine module for processing;
the state machine module, interfaced with the service end access interface module, is configured to provide validity detection for an operation of a customer representative according to a position state and/or a call state, and maintain the position state and the call state according to a TSAPI message and a SIP message that have been received;
the service end access interface module is configured to provide interfaces of position state and call state control for the customer representative.

2. The background service process unit according to claim 1, wherein, the protocol stack module specifically comprises a TSAPI protocol stack module and a SIP protocol stack module, and the state machine module specifically comprises a position state machine module and a call state machine module; wherein,
the TSAPI protocol stack module, connected to a CTI server through an IP network, is configured to create and release a TSAPI connection, send and receive a TSAPI message, analyze an acknowledgment of message sending and content of a received message, and deliver an analyzed message to the position state machine module for processing;
the SIP protocol stack module, connected to the automatic call distributor through an IP network, is configured to send and receive a SIP message, analyze the received SIP message and deliver the analyzed SIP message to the call state machine module for processing;
the position state machine module is configured to maintain the state of a position according to a received TSAPI message, and provide control and query of the position state;
the call state machine module is configured to maintain the state of a call according to a TSAPI message and a SIP message that have been received, provide call state query, call control operation and operation validity detection.

3. The background service process unit according to claim 1, wherein the background service process unit further comprises: a FTP protocol stack module and an update detection module; wherein,
the FTP protocol stack module, configured to provide FTP file transfer ability;
the update detection module, communicating with the service end access interface module and the FTP protocol stack module, configured to inquire a FTP server regularly through the FTP protocol stack module, check whether a position software has an update, and if an update is discovered, initiate a FTP operation to download the update and register a new position software.

4. The background service process unit according to claim 2, wherein, the background service process unit further comprises: a RTP protocol stack module and a media encoding and decoding module; wherein,
the RTP protocol stack module, configured to send and receive media stream packets under control of the SIP protocol stack module, and deliver received media data to a media encoding and decoding module for processing;
the media encoding and decoding module, communicating with the RTP protocol stack module and responsible for encoding and decoding operations of the media data, configured to, after a voice captured by a voice capturing device is converted into digital signals by a voice card, perform encoding compression to the digital signals obtained after the conversion, encapsulate the digital signals after the encoding compression into a RTP message, which is then sent to a correspondent node through the RTP protocol stack module, and deliver decoded data streams to the voice card for synthesis and playback.

5. The background service process unit according to claim 1, wherein the background service process unit further comprises:
a data access client module, communicating with the service end access interface module, configured to provide access function of a position system database for the customer representative after the customer representative initiates a data query operation through an operation page;
the service end access interface module is further configured to provide an access interface of the position system database for the customer representative.

6. A browser based position system, comprises a browser and a background service process unit, wherein,
the browser is configured to send an operation request according to a customer representative to the background service process unit through an operation page, the browser comprises an interface access object, which is configured to send the operation request from the customer representative to a service end access interface module of the background service process unit;
the background service process unit, connected to a CTI server and an automatic call distributor, is configured to receive the operation request, judge whether the operation can be performed currently, if yes, send the operation request to the CTI server through a TSAPI protocol, and make a corresponding switching to a position state after receiving an operation completion notification message sent by the CTI server;
the CTI server forwards the received operation request to the automatic call distributor for performing, and forwards, after the performing is completed, the operation completion notification message sent by the automatic call distributor to the background service process unit.

7. The system according to claim 6, wherein,
The browser is further configured to send a login request from the customer representative to the background service process unit through a login page, and switch a current login page to the operation page after receiving a returned login result message;
the background service process unit is further configured to receive the login request, judge whether the customer representative can perform a login operation currently, if yes, then initiate a TSAPI protocol registration to the CTI server, and set a corresponding position state and initiate a SIP protocol registration to the automatic call distributor after the TSAPI protocol registration is successful, and set a corresponding call state and send a login result to the login page opened by the customer representative after the SIP protocol registration is successful.

8. A method for call control of a browser based position system comprises steps:
A, a browser sending an operation request according to a customer representative to a background service process unit through an operation page;
B, the background service process unit receiving the operation request, and judging whether the operation can be performed currently, if yes, sending the operation request to a CTI server;
C, the CTI server forwarding the received operation request to an automatic call distributor for performing, and forwarding an operation completion notification message sent by the automatic call distributor to the background service process unit after the operation request is performed completely;
D, the background service process unit making a corresponding switching to a position state according to the received operation completion notification message.

9. The method according to claim 8, wherein, the specific process for the automatic call distributor to perform the operation are as follows:
after receiving the operation request, the automatic call distributor sending a corresponding operation command to the background service process unit through a SIP protocol;
after receiving the operation command, the background service process unit performing a corresponding media stream control operation, and making a corresponding switching to a call state, thereafter returning an operation completion confirmation message to the automatic call distributor through the SIP protocol;
after receiving the operation completion confirmation message, the automatic call distributor sending an operation completion notification message to the CTI server.

10. The method according to claim 8, wherein, before the step A, the method further comprises the following steps:
the browser sending a login request of the customer representative to the background service process unit through a login page;
the background service process unit receiving the login request, and judging whether the customer representative can perform a login operation currently, if yes, initiating a TSAPI protocol registration to the CTI server, setting a corresponding position state and initiating a SIP protocol registration to the automatic call distributor after the TSAPI protocol registration is successful, and setting a corresponding call state and sending a login result to the login page which is opened by the position after the SIP protocol registration is successful.

11. The method according to claim 9, wherein after receiving the login request, when the background service process unit judges whether the customer representative can perform the login operation currently, if the background service process unit discovers the customer representative is currently in a conversation state and a current service session is not connected to the customer representative, the background service process unit returns a message for prompting whether to connect to the service session to the login page, and when receiving a returned connection request, the background service process unit recreates a connection for the service session.

12. The background service process unit according to claim 2, wherein the background service process unit further comprises: a FTP protocol stack module and an update detection module; wherein,
the FTP protocol stack module, configured to provide FTP file transfer ability;
the update detection module, communicating with the service end access interface module and the FTP protocol stack module, configured to inquire a FTP server regularly through the FTP protocol stack module, check whether a position software has an update, and if an update is discovered, initiate a FTP operation to download the update and register a new position software.

13. The background service process unit according to claim 2, wherein the background service process unit further comprises:
a data access client module, communicating with the service end access interface module, configured to provide access function of a position system database for the customer representative after the customer representative initiates a data query operation through an operation page;
the service end access interface module is further configured to provide an access interface of the position system database for the customer representative.
